(19) United States
(12) Patent Application Publication
(10) Pub. No.: US 2003/0140315 A1
(43) Pub. Date: Jul. 24, 2003

(54) PRINT ON DEMAND VIRTUAL BUILDER

(76) Inventors: ROBERT EVANS BLUMBERG, SANTA CRUZ, CA (US); PAUL ALISTAIR MORGAN, APTOS, CA (US)

Correspondence Address: FINNEGAN, HENDERSON, FARABOW, GARRETT & DUNNER, LLP, 1300 I STREET, NW, WASHINGTON, DC, 20005, US

(21) Appl. No.: 09/326,991

(22) Filed: Jun. 7, 1999

(51) Int. Cl. G06F 17/24

(52) U.S. Cl. 715/527

(57) ABSTRACT

A method for creating and viewing content to be printed, including the steps of receiving an electronic document, selecting, in response to user input, finishing options for the electronic document, and displaying, in response to the selecting, how the electronic document would appear as a finished document, if printed in accordance with the finishing options. A system is also described and claimed.

### FIELD OF THE INVENTION

The present invention relates to computerized print on demand services.

### BACKGROUND OF THE INVENTION

With the advent of Internet-based electronic commerce, vendors are employing on-line transaction software to sell their goods and services over the Internet. Purchase of goods is typically performed through a web browser. A user opens an appropriate web page that includes descriptions of one or more goods, and selects to purchase one or more of them. Typically, transaction software accumulates a user's selected items in a virtual “shopping cart.” When the user has completed his selections, he issues an order to purchase the selected goods, the order including delivery information.

The user's order is processed by transaction software residing on a web server. The transaction software prompts the user for billing information, such as the user's credit card information, and bills the user. Typically, transaction software uses secure HTTP or such other secure protocol, to protect the user's confidential information. Following acceptance of an order, a notification is typically sent to the user via e-mail.

An example of an electronic commerce web site is http://www.amazon.com, the site of Amazon.com, Inc. of Seattle, Wash., where books, audio CDs and video cassettes are sold.

Purchase of services over the Internet is less standardized, since services can be provided in many different ways. For example, information services can be provided directly on-line, and travel services can be provided by delivering an airline ticket to a user.

The present specification concerns on-demand on-line printing services. Prior art on-line printing services enable a user to send an on-line print order to a print facility, using descriptive text to specify the order, or using fixed pre-selected templates. For example, if a user wishes to order copies of a document, he can specify what he wants to order using a text-based menu-driven interface. For another example, if a user wishes to order business cards, he can select from a set of templates, and specify his own substitute text to be inserted.

Prior art on-line printing services suffer from insufficient visual presentation. In distinction, it is noted that today's word processors, such as Microsoft® Word of Microsoft Corporation in Redmond, Wash., are rich in visual presentation, and provide a WYSIWYG (“what you see is what you get”) user interface. However, prior art printing services do not go beyond basic document visual presentation. Visualization beyond the basic document, that would have the “look and feel” of a finished document, is lacking. As such, when a user orders a printed product using prior art on-line printing services, he is uncertain as to what the finished document will actually look like.

Prior art printing services rely on a physical hardcopy “proof” to show a user what his finished document will look like. However, when ordering printed products over the Internet, a typical user may be situated remotely from the printing facility. As such, transmission of a proof and ensuing user alterations back and forth between the user and the printing facility is cumbersome. In fact, the difficulty of examining a proof of a finished document is one of the primary drawbacks of on-line printing services.

### SUMMARY OF THE INVENTION

The present invention provides an on-line on-demand printing service that enables a user to interactively create and view a finished document, such as a bound book, an eight-page brochure or a customized business card. A user using the present invention can see on his video monitor how a document will look as a finished document, with selected front and back covers, selected binding, selected inserts, selected paper type, size and grain, selected imposition, selected folding, selected lamination, selected hole punching, and other selected finishing options. A user using the present invention can also see on his video monitor how a printed product such as a business card will look as a finished document with his own name, company address and logo inserted.

The present invention uses “Virtual Builder” viewer software that displays a proof of how a finished document looks with selected finishing options applied. In effect, Virtual Builder “builds” for a user a virtual finished document. Virtual Builder accepts user-selected finishing options, or alternatively, pre-selected finishing options stored in a job description file. Virtual Builder also employs pre-designed templates for finished documents, which a user can customize for himself.

There are two kinds of proofing involved with printed documents. The first kind is content-level proofing, and is typically accomplished with viewers such as Microsoft® Word of Microsoft Corporation of Redmond, Wash. and Adobe® Reader of Adobe Systems, Inc. of San Jose, Calif. Content-level proofing enables a user to view the text and graphics within a document.

The second kind of proofing is document-level proofing, which includes both content (i.e. the computer files) and finishing options (e.g., covers, binding, tabs and paper types).

It can thus be appreciated that Virtual Builder provides a WYSIWYG user interface for on-line printing services. It can further be appreciated that the present invention overcomes a primary disadvantage of on-line printing services, and enables such services to generate finished documents that meet user expectations without the medium of a physical proof.

There is thus provided in accordance with a preferred embodiment of the present invention a method for creating and viewing content to be printed, including the steps of receiving an electronic document, selecting, in response to user input, finishing options for the electronic document, and displaying, in response to the selecting, how the electronic document would appear as a finished document, if printed in accordance with the finishing options.

There is further provided in accordance with a preferred embodiment of the present invention a method for creating and viewing content to be printed, including the steps of receiving an electronic document, selecting, in response to user input, finishing options for the electronic document, and storing the finishing options electronically.

There is further provided in accordance with a preferred embodiment of the present invention a system for creating and viewing content to be printed, including an input unit receiving an electronic document, a user interface setting, in response to user input, finishing options for the electronic document, and a display device displaying how the electronic document would appear as a finished document, if printed in accordance with the finishing options.

There is further provided in accordance with a preferred embodiment of the present invention a system for creating and viewing content to be printed, including an input unit receiving an electronic document, a user interface setting, in response to user input, finishing options for the electronic document, and a memory storing the finishing options electronically.

There is further provided in accordance with a preferred embodiment of the present invention a method for viewing content to be printed using electronically stored finishing options, including the steps of retrieving the finishing options, and displaying the electronic document in accordance with the finishing options.

There is further provided in accordance with a preferred embodiment of the present invention a system for viewing content to be printed using electronically stored finishing options, including a memory storing the finishing options, and a display device displaying the electronic document in accordance with the finishing options.

### BRIEF DESCRIPTION OF THE DRAWINGS

The present invention will be more fully understood and appreciated from the following detailed description, taken in conjunction with the drawings in which:

FIG. 1 is a simplified illustration of a preferred user interface display from Virtual Builder viewer software, displaying a finished document with user selected finishing options, in accordance with a preferred embodiment of the present invention;

FIG. 2 is an illustration of components of an on-demand printing service residing within a corporate intranet, in accordance with a preferred embodiment of the present invention;

FIG. 3 is an illustration of components of an on-line printing service residing within an on-line on-demand printing facility, in accordance with a preferred embodiment of the present invention;

FIG. 4 is an illustration of client software that uses an on-demand printing service of the present invention;

FIG. 5 is an illustration of software components interfacing with a Virtual Builder server and a Virtual Builder client applet; and

FIG. 6 is a simplified flowchart of the operation of Virtual Builder in an example user session, in accordance with a preferred embodiment of the present invention.

### DETAILED DESCRIPTION OF A PREFERRED EMBODIMENT

The present invention concerns systems for on-line on-demand printing services that enable a user to interactively create and order print jobs via a computer network. The computer network can be the Internet, a corporate intranet or any other suitable network connecting computers and peripheral output devices. The present invention enables a user to view on-line a proof of a finished print job, as it would look with user selected finishing options applied.

In one embodiment, intended for use over the Internet and referred to as an “Internet print on demand service,” the present invention enables a user to submit over the Internet his own document, and to select over the Internet various finishing options for printing. As used in the present specification, “finishing options” refer to physical attributes of a printed document that are not related to the content of the document. Examples of finishing options include type of paper (grain, weight, size and color), type of binding, types of front and back covers, type of tab inserts, type of lamination, type of folding and type of hole punching.

In order to include all forms of printed matter, the term “document” as used in the present specification refers to any electronic file with formatted text and/or graphics. A document includes conventional documents produced with word processing software, as well as stationary, envelopes, business cards, calendars, greeting cards, flyers, brochures, booklets, datasheets, newsletters and other printed matter.

The print on demand service of the present invention includes a user interface that enables a user to select finishing options and interactively displays a proof of how the finished document will look when the user's selected finishing options are applied. The finishing options selected by a user can be stored as a job description file that is associated with the user's document.

A job description file contains information about how to print a document, similar to the way job tickets are used with PDF documents. The Portable Job Ticket Format of Adobe is described in Adobe Developer Support Technical Note #5620, Version 1.1, Apr. 2, 1999, which is available on the web as file 5620.pdf at http://partners.adobe.com/supportservice/devrelations/ technotes.html#pjt.

The Internet print on demand service of the present invention also includes software that prices and schedules a print job, accepts orders for printing the job along with delivery instructions, routes the job to a print service provider production center, and bills the user. The service interfaces with inventory databases, and bases the information it provides on availability of inventory and on allowable product sets available to the user.

Allowable product sets are used to restrict use of certain finishing options or combinations of finishing options. Allowable product sets can be controlled to restrict printing with a set of finishing options for which pricing is competitive. For example, a corporate user may not be allowed to print in color. Allowable product sets can be administered by a user's manager, in the case of a corporate intranet, or by a user himself.

The Internet print on demand service of the present invention typically sends job orders for finished documents to a print service provider production center, such as a quick printer or a commercial printer, which will handle production. Preferably, the print service provider has a production interface that includes the following features:

scrolling list of incoming jobs;

ability to enter status of a job (e.g., waiting to be printed, printed, waiting for folding, shipped);

display of finishing options to be applied; and

delivery information.

Once a user places an order for a prescribed number of copies of his job, the Internet print on demand service prioritizes the user's job and routes it to the appropriate production center. The service also allows staff in the production center to update the job status, and provides the user with current status information as to his job's progress.

The Internet print on demand service of the present invention also uses finished document templates that enable a user to view, customize and order personalized printing products, such as stationary, envelopes, business cards, calendars, greeting cards and invitations. A template includes a pre-constructed set of finishing options that are to be applied to a document. Templates are also used for creating and ordering types of products having styles that a printing company has pre-designed, such as folders, flyers, four-page glossy brochures, eight-page brochures with cut-outs and inserts, and sixteen-page booklets.

In a second embodiment, intended for use within corporate intranets and referred to as an “intranet print on demand service,” the present invention enables a company to create and manage its own finished documents, such as corporate sales and marketing brochures, datasheets, manuals and training materials. A user of the intranet print on demand service can view and order over an intranet a centrally archived document, with selected finishing options applied, such as those described hereinabove. Alternatively, the user may use pre-selected finishing options that are stored as a job description file associated with a document. The present invention includes a user interface that enables a user who selects a document to interactively view a proof of the document as a finished document with the finishing options applied.

The intranet print on demand service of the present invention enables the user to order a prescribed number of copies of a job, and the service prioritizes the user's job and routes it to an appropriate print service provider production center. The print service provider may be an in-house printing center or an external service provider, such as a quick printer or a commercial printer.

The intranet print on demand service of the present invention tracks the job and provides the user with current status information as to his job's progress. The print on demand service also interfaces with inventory databases, and bases its job schedules on availability of inventory and on allowable product sets available to the user, as described hereinabove.

Two features of the present invention that are common to both the Internet and intranet print on demand services are: (i) the ability to view on a computer video monitor a finished document with finishing options applied, and (ii) the ability to store finishing options as an electronic job file.

The print on demand services of the present invention are managed by software that includes the following components:

1. client-side and server-side creation tools and viewers (“Virtual Builder”);

2. document handler (e.g. PDF library);

3. transaction server (cost determination, job orders and billing);

4. order management software (tracking, routing, delivery);

5. administration software (remote control panel and administration, system configuration);

6. inventory database software; and

7. pricing database software. Optionally, the printing systems may also include the following additional components:

8. color management software;

9. document management software;

10. image server; and

11. PDF server.

Each of these components is described hereinbelow.

Client-side and Server-side Creation Tools and Viewers

Creation and viewer software, referred to as “Virtual Builder,” is used to create and interactively view a finished document, with user selected finishing options applied. As a user changes his selection of finishing options, Virtual Builder changes the display appropriately. When a document is displayed as a finished document by Virtual Builder, the user can inspect the finished document by interactively paging through the document and by enlarging or reducing the view magnification. Virtual Builder visually carries out the binding, inclusion of inserts, imposition, paper selection, front and back cover selection and other finishing options selected by a user.

When operating within a client-server distributed computing environment, Virtual Builder can reside on client computers or server computers, or preferably both, as described in detail hereinbelow. When Virtual Builder, or a portion of Virtual Builder, resides on client computers, it can be implemented using various software architectures, including an ActiveX control, a Netscape plug-in, a Java applet, or even a standalone application. In a preferred embodiment, the present invention implements a portion of Virtual Builder on client computers using a Java applet. Java applets are convenient in that they are stored on server computers, and downloaded to each client computer the first time the client computer uses Virtual Builder. Thereafter they are not downloaded to the client computer again, unless the applet has subsequently been updated.

When Virtual Builder resides entirely on server computers, it is preferably implemented by software that interactively provides data compliant with HTML pages or XML pages, or other such layout pages that are comprehensible to web browser software, on a client computer. Web browsers are capable of rendering and displaying HTML and XML pages, but may not be able to render and display other formats, unless the web browsers are supplemented by additional software on the client computer. In distinction, when a portion of Virtual Builder resides on client computers, it can provide data using any convenient format, since it does not need to use a web browser for rendering and displaying its graphics.

A user of Virtual Builder preferably connects to an enabled server computer and specifies one or more document files to be printed. The one or more document files may reside on the enabled server computer, or alternatively, they may reside on one or more different computers, in which case they are transmitted to an enabled server computer for processing.

When Virtual Builder viewer resides entirely on a client computer, there is no need to transmit a document file from the client to a server computer in order to view it.

Virtual Builder User Interface

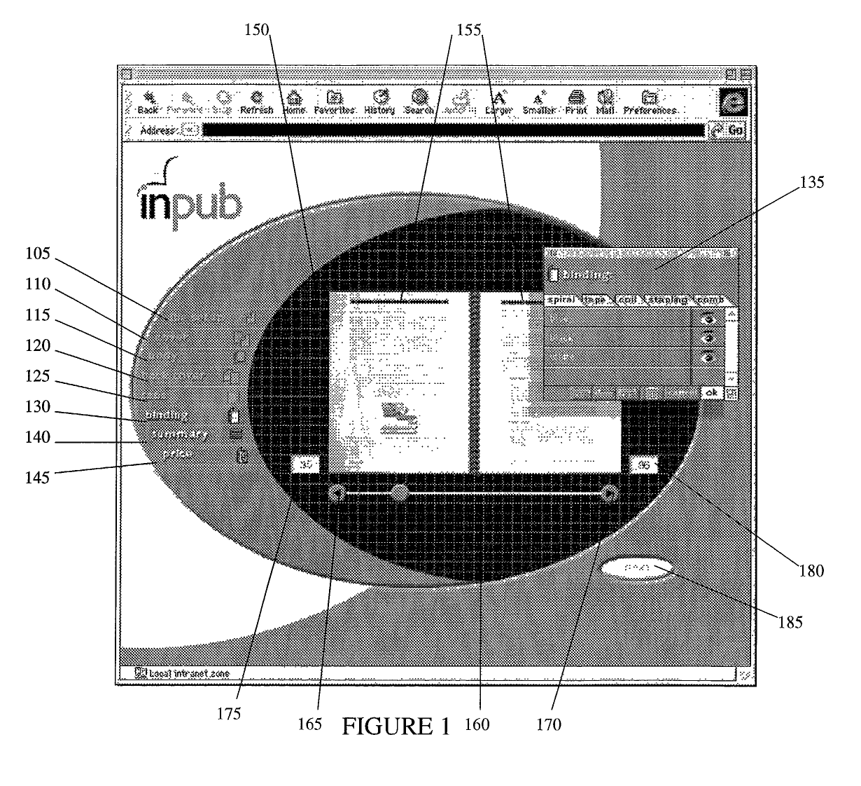

The enabled server computer presents the user with an interface that enables him to select various finishing options. Reference is now made to FIG. 1 which illustrates a preferred user interface display from Virtual Builder viewer software, displaying a finished document with user selected finishing options, in accordance with a preferred embodiment of the present invention. A set of menu options 105, 110, 115, 120, 125 and 130 on the left enable a user to select a document file, a cover, a body, a back cover, tabs and binding, respectively.

File setup option 105 enables a user to indicate one or more documents to import into Virtual Builder. Imported documents preferably include text documents, text documents with embedded graphics, charts, spreadsheets, slide show presentations, database displays, and other types of documents.

Cover option 110 enables a user to select a front cover. Cover selection preferably includes selection of soft or hard cover, cover weight, cover color, embossing and other features.

Body option 115 enables a user to select paper type for the body of the document. Paper type selection preferably includes selection of paper grain, weight, size, color and other features. Moreover, some pages of the document can be printed on different pages than others; for example, the first few pages may be printed on colored paper, and the remaining pages printed on white paper.

Back cover option 120 enables a user to select a back cover. Back cover selection should preferably partially conform in style to front cover selection. Back cover selection preferably includes selection of soft or hard cover, cover weight, cover color, and other features.

Tabs option 125 enables a user to select tab inserts.

Binding option 130 enables a user to select a binding. Binding selection preferably includes selection from among stitched binding, tape binding, coil binding, glued binding, spiral binding, punched binding, staples, combinations of the aforesaid bindings, and other forms of binding. Preferably binding selection also includes selection of binding color and weight.

Upon activation, each menu item invokes a dialogue box 135 with specific finishing options. Dialogue box 135 illustrated in FIG. 1 is a dialogue box for selecting binding options, and is invoked by selecting binding menu option 130 on the left. As illustrated in FIG. 1, dialogue box 135 for selection of binding preferably includes menu items for selecting spiral, tape, coil, stapling and combination bindings. As further illustrated in FIG. 1, the spiral menu option includes selection of spiral color.

A summary option 140 enables a user to review all of the finishing options he has selected, and a price option 145 displays the price of producing various numbers of copies. Alternatively, price option 145 can display the price of a designated number of copies.

In a preferred embodiment of the present invention, when a user selects a set of finishing options, Virtual Builder prices the job based on a number of copies ordered and based on a delivery option selected. Preferably, Virtual Builder uses a pricing database and an inventory system to determine its pricing, as described hereinbelow.

The document file is displayed by Virtual Builder as a book 150 with two stacks 155 of pages, shown in FIG. 1 with spiral binding. A slide bar 160 with directional left and right directional arrows 165 and 170, respectively, enables a user to page back and forth through the book. The left and right page numbers are indicated in page display boxes 175 and 180, respectively. A “next” button 185 enables the user to advance forward through successive pages of the document.

As seen in FIG. 1, Virtual Builder displays a virtual representation of a “logical document.” A logical document includes fragments of one or more physical documents. When creating a new finished document, a user can select a document template as described hereinbelow, and the initial display is based on the selected template. As described hereinabove, a template includes a pre-constructed set of finishing options that are to be applied to a document. If no document template is selected, then one or two stacks of single sided standard white paper with black and white print are preferably displayed.

Interaction with Virtual Builder preferably follows the basic flow of:

Selecting a document type (e.g., business card, brochure) and, optionally, a document template, by a user;

displaying a view of a virtual representation of a document, by Virtual Builder;

selecting a page or a range of pages, by a user;

performing a legal operation on the selected page or range of pages, by a user; and

updating a view of a virtual representation of a document, by Virtual Builder.

The document is preferably rendered as two stacks of pages, like a book. Orientation of the pages depends on the orientation of the binding. If no binding is specified or if a left bind is specified, the stacks appear side by side. If a top bind is specified, the stacks appear above and below each other.

A user navigates through the document by turning pages. With reference to FIG. 1, page turning is preferably carried out as follows:

clicking on a stack 155 causes the page on top of the stack to move to the other stack;

clicking on one of the direction arrows 165 or 170 causes pages to move from one stack to the other, one at a time;

sliding the slider bar 160 under the document causes rapid page turns from one stack to the other;

entering a desired page number in one of the page display boxes 175 and 180 causes the document to advance to the entered page; and

if a document has tabs, then clicking on a tab causes the document to advance to that tab.

The turning of a page in a document is preferably animated. To avoid the animation becoming excessive, the speed of animation preferably increases with the frequency of turning. The number of partial page impressions necessary to animate a page turn preferably depends on the timing of the page turn and the speed of the computer running Virtual Builder.

In a preferred embodiment of the present invention, to select a side of a page the CTRL key is depressed while clicking on an image of a page. This operation highlights the selected page. Multiple page sides can be selected by repeating this operation. CTRL-clicking on the same page after selection causes the page to be de-selected. To select a range of pages one selects while the pages are turning, which can be achieved by CTRL-clicking on a page and holding the left mouse key down while moving the mouse in the direction in which the pages should turn. The document pages automatically turn at a rate that depends on how far the cursor is from the edge of the page. As soon as the cursor is moved inside the page boundary, the automatic page turning stops. Moving the cursor over an opposite page causes a page to be de-selected, and further movement in this direction causes pages to turn in the opposite direction.

As pages are selected the selection is displayed as a comma separated list of selections; e.g., “2, 7-10, 24” denotes pages 2, 7, 8, 9, 10 and 24. Pages can also be selected by manually editing the selection list. Any selection of pages can be cleared by clicking on a “selection reset” button, which resets the selection list.

Preferably several convenient quick selection methods are available, including selection of the front cover, the back cover, the document body (all pages except the front and back covers), and all tabs (if the document contains tabs).

Once a required page selection is made, a user can edit properties of the selected pages, from among properties displayed on a property sheet. If multiple pages are selected and there is ambiguity between properties, the ambiguous properties are grayed-out. Changing an unambiguous property resets the property in all the selected pages to the new property value. When the property sheet is closed, the virtual document representation is updated and the document can be navigated without disabling the current page selection.

The number of modifiable properties is reduced if more than one page type is selected. For example, if both regular pages and inserts, such as tabs, are selected, then the only unambiguous property may relate to deletion of the pages and the tabs, since a tab insert has very different properties than those of a regular printed page.

To distinguish between selection of a page and selection of a side of a page, the page properties pop-up sheet has two sections. “Side” properties relate to selected sides, and “page” properties related to both the front and back sides of a selected page, regardless of whether one or two sides are selected. When a user selects a page, he can edit the actual media (i.e., the paper) itself, or the printing on a side (i.e., a face) of the page. Media edit options include modification of paper type and lamination, which apply to both sides of a page. Side options include the printing process, such as black & white vs. color reproduction, or the application of a gloss coat in high-end printing, or scaling of text and graphics, which may be different on the front and back sides of a page.

Preferably, to distinguish between “page” properties and “side” properties, the Virtual Builder user interface provides different “tabs” of property information on a property sheet, one tab for a section that applies to the media (paper selection), and another tab for a section that applies to the printing process.

Preferably, formatting operations that apply to the document as a whole, such as binding and finishing options, can be performed at any time by selecting “binding” or “finishing” menus.

After the user selects a set of finishing options for a document, Virtual Builder preferably saves the options in a job description file. The job description file is associated with the document upon printing.

Traditionally, when working with a new order such as a marketing brochure, printing companies show their customers a variety of samples, each sample having its own specific style. The customer selects one of the styles and personalizes it with his own content. For example, a sample of a marketing brochure can have a design of a folder with inserts with areas of text and graphics. A customer can insert his own text and graphics into the brochure, and order such a product. Printing companies can differentiate themselves by the styles of products they offer.

To support this type of product-based ordering, Virtual Builder preferably uses pre-designed templates for various styles of finished documents. A user can select a style from a library of available styles, and Virtual Builder displays the finished document in the selected style. The user can insert his own text and graphics into the style, as the layout of the style permits. The user can navigate through his finished document with a user interface, such as the one described hereinabove. He can turn pages of the document, examine the paper on which the document is printed and change its properties, examine the front and back covers and change their properties, examine the binding and change its properties, examine the tab inserts and change their properties, and perform other such operations.

Preferably, the library of available styles is based on a selected print facility, since different print facilities typically offer different selections of styles. Use of templates enables a user to create documents with sophisticated styles, without having to create the style himself. In addition, the styles of templates are preferably designed in such a way that they conform to printing and folding operations that are easy to implement. For example, an eight-page booklet can be produced by printing on a single large page that is folded in half three times, cutting appropriate folds and stapling twice in the center. In distinction, when a user designs his own style of document, it may be complicated to produce.

In a preferred embodiment of the present invention, Virtual Builder maintains a list of registered printing companies, together with a description of their capabilities, their pricing and their library of pre-designed document styles.

It can thus be seen that an advantage of Virtual Builder over traditional on-line printing services is that a user can try out multiple styles, personalizing them and altering them on-line, using Virtual Builder to display corresponding proofs, without the need for the user to have to envision how his own text and graphics would appear inserted into a reference sample, and without the need for the printing company to run off physical samples in multiple styles. A user can try out all the styles offered by a printing company with multiple versions of text and graphics inserted, entirely on-line.

In a preferred embodiment of the present invention, Virtual Builder invokes different user interfaces for different modes of operation, such as standard documents, brochures, business cards, letterheads and mugs.

Although Virtual Builder has been described hereinabove with reference to a specific print service, for the sake of definiteness and clarity, it is to be appreciated that Virtual Builder is modular software that can be integrated within a wide variety of configurations. Such a configuration, for example, need not include the other system elements listed above, such as transaction server software, order management software, administration software, color management software, document management software, image server software or PDF server software.

Document Handler

Document handler software is preferably part of the Virtual Builder software. It is used by Virtual Builder to render views, similar to the view illustrated in FIG. 1, of a document as a finished document.

The documents used in the printing systems of the present invention are preferably documents stored in the Portable Document Format (PDF) of Adobe Systems, Inc. of San Jose, Calif. In order to render pages of such a document as they appear within a finished document, it is necessary to extract text and formatting information from the document. Adobe Systems provides a PDF library with an application programming interface (API) that serves as a PDF document handler, and enables a software application developer to access objects contained within a PDF document.

Alternatively, software such as ghostscript and 5D may be used instead of the Adobe PDF library. Ghostscript is a GNU PostScript language interpreter, with the ability to convert PostScript language files to many raster formats, view them on displays and print them on printers that do not have built-in PostScript capability. Information about Ghostscript is available on the web at http://www.cs.wisc.edu/˜ghost/. 5D is available from Fifth Dimension Systems, Ltd. of Berkshire, England, information about which can be obtained on the web at http://www.5d.co.uk.

Transaction Server

Transaction server software handles electronic transactions. When a user issues a request for a job order, the transaction server handles the order. The transaction server prompts the user for credit card or other such payment information. The transaction server provides the payment information to an appropriate print service provider who then bills the user, or alternatively, the transaction software may bill the user's credit card directly.

The transaction software preferably provides a secure mode of communication, such as via secure HTTP, also referred to as HTTPS, and processes the user's order.

The transaction software is responsible for recording each transaction it processes, and for sending a notification to a user of the actual billing of his charge account. Such a notification is typically sent via e-mail.

Order Management Software

When a user places a job order via the transaction server, order management software assigns a tracking identification number to the user's job, and monitors the job's progress as it proceeds through the workflow. The tracking identification number is preferably sent to the user, typically by e-mail. The user can subsequently determine the status of his job by querying the order management software using the tracking identification number assigned to the job.

Order management software is also responsible for routing the user's job to appropriate print service providers. When a job is completed, order management software is responsible for providing the job delivery requirements.

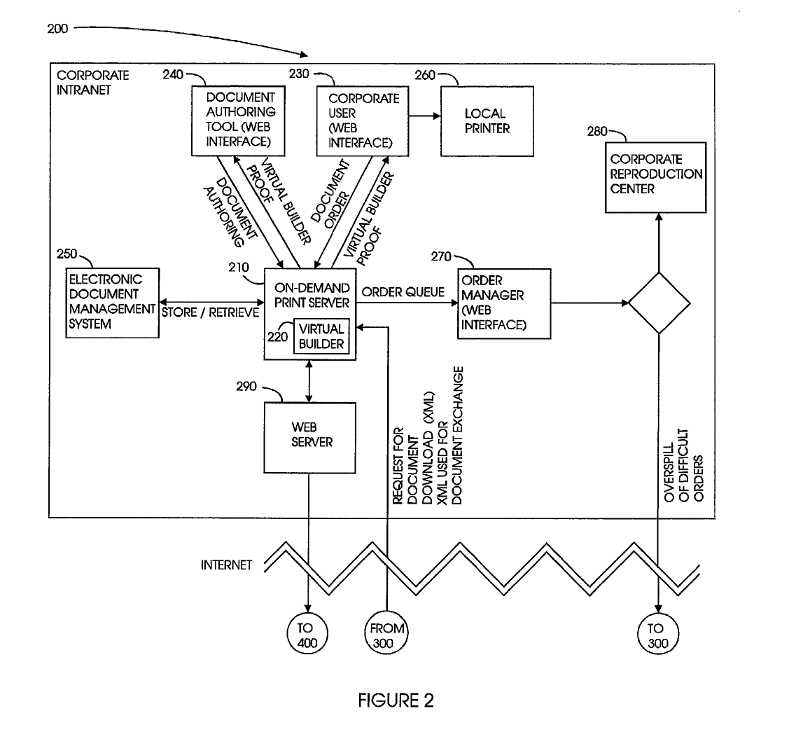

Order management software is described hereinbelow with reference to FIG. 2.

Administration Software

Administration software is used to specify the configuration of network devices, such as computers and printers, and to control and monitor job flow and job prioritization.

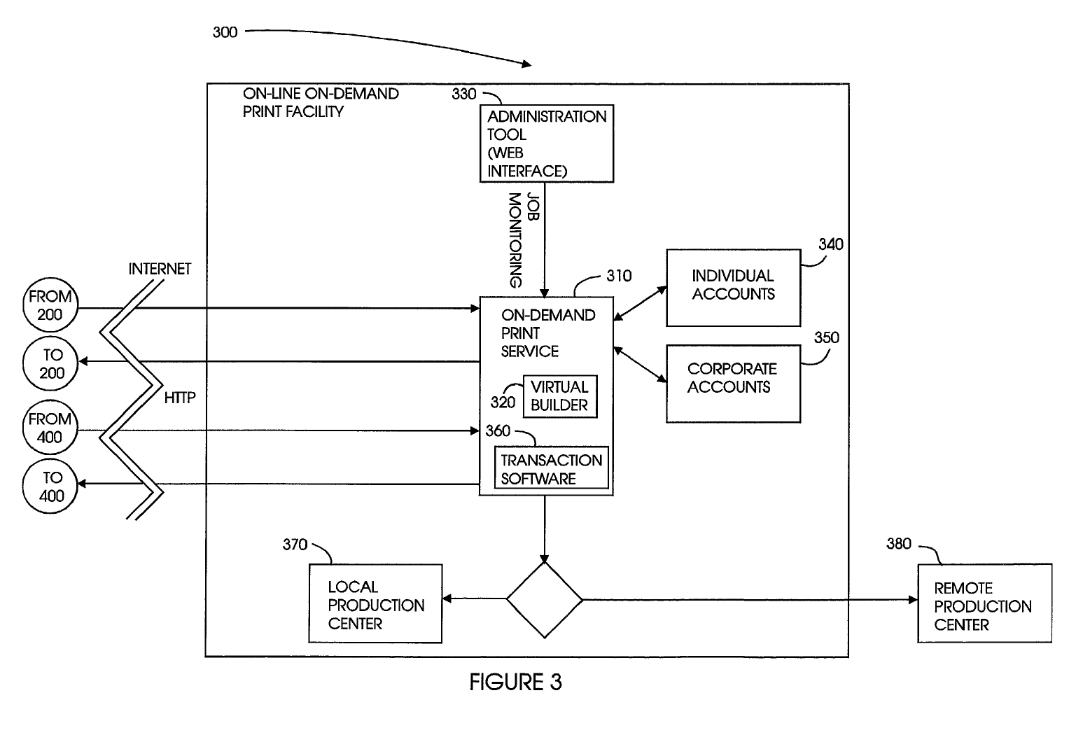

Administration software is described hereinbelow with reference to FIG. 3.

Inventory Database Software

Inventory database software manages a dynamic inventory database of available printing materials, such as paper, covers, bindings and tabs, for multiple print service providers. It provides information on availability of inventory at various print service provider production centers, and is used by order management software to determine a schedule for a job.

Pricing Database Software

Pricing database software determines the price of printing a job. Preferably pricing database software incorporates pricings for one or more of a multiplicity of print service providers. Preferably, the price of a job depends on:

the job itself, including all finishing options;

requested turnaround time (e.g., standard/rushed);

quantity; and

physical delivery requirements (e.g., same day/next day).

Pricing can be based on the materials required in the finishing options, such as paper, front and back covers and binding. Alternatively, pricing can be based on specific product types, such as prices for business cards, prices for stationary, prices for flyers, prices for four page brochures and prices for sixteen page booklets.

Color Management Software

Color management is becoming increasingly accurate for matching colors produced on a video display with colors produced by an output device such as a color printer. The International Color Consortium (ICC) has introduced ICC profiles, used to transform device-dependent colors from one device to another. When an ICC profile is provided for a specific color space, multiple devices can accurately convert color from the specific color space to native device color spaces. Information about ICC profiles is available on the Web, at http://www.color.org. Adobe Acrobat 4 supports ICC profiles embedded within PDF documents.

When a client computer contains color management software capable of performing ICC color space transformations, Virtual Builder should preferably use such color management software to apply ICC profiles that are embedded within documents. In this way, Virtual Builder can match colors between a video display and an output device, so that a user sees in the proof of a finished document on a video display the true colors that appear in the finished document when it is printed.

Document Management Software

Document management software is used to manage access to an archive of electronic documents. Such software organizes the documents into files and folders, provides access control to restrict access to designated documents by unauthenticated users, and provides search capability to retrieve documents with particular features. An example of an electronic document management system is the Documentum® Enterprise Document Management System of Documentum, Inc. of Pleasanton, Calif.

Document management software is described hereinbelow with reference to FIG. 2.

Image Server

Image server software is used to distribute high resolution images embedded within documents. Image servers are able to transmit the image data necessary to render a specific portion of an image at a specific resolution. One such image server is the Live Picture® Image Server, available from Live Picture, Inc. of Campbell, Calif. The Live Picture Image Server uses the Flashpix™ file format, which stores an image as a pyramidal hierarchy of increasing resolutions. The Live Picture Image Server also uses the Internet Imaging Protocol to transfer image tiles from specific resolutions of a Flashpix image. Specifications for the Flashpix file format and the Internet Imaging Protocol are available on the Internet at http://www.digitalimaging.org.

PDF Server

PDF server software is used to enable web browsers to display PDF documents. It bears a resemblance to an image server, in that it converts a specific portion of a page of a document at a specific resolution into an HTML page or an XML page, or into such other Web-ready page as may be rendered by a standard web browser on a client computer. Use of a PDF server precludes the need to supplement a web browser with additional client software.

Print on Demand Service Systems

Reference is now made to FIG. 2, which illustrates components of an on-demand printing service residing within a corporate intranet 200, in accordance with a preferred embodiment of the present invention. Corporate intranet 200 contains an on-demand print server 210 that includes Virtual Builder viewer software 220. Virtual Builder 220 preferably includes document handler software, and enables an author of a document to view the document as a finished document with selected finishing options applied, as described hereinabove. On-demand print server 210 enables a corporate user 230 to order and re-order printing of corporate documents, through a web interface.

Corporate intranet 200 also includes a document authoring tool 240 with a web interface, for producing finished documents. The documents produced by document authoring tool 240 can be viewed and manipulated by Virtual Builder 220. Documents produced by document authoring tool 240 are preferably uploaded to on-demand print server 210, which stores the documents using an electronic document management system 250. Stored documents are accessible to corporate users such as corporate user 230.

An author of a document can optionally save a selected set of finishing options as a job description file, along with the document, using electronic document management system 250, so that corporate users such as corporate user 230 can have pre-selected finishing options available to them.

Corporate user 230 can view a document stored on on-demand print server 210 with user selected finishing options, using Virtual Builder 220. Alternatively, if a job description file is available for such a document, corporate user 230 can view the document with pre-selected finishing options.

For a specific set of finishing options, corporate user 230 can order one or more copies of a document stored on on-demand print server 210. Alternatively, for content-level proofing, corporate user 230 can download and print the document without finishing options using appropriate desktop publishing software on a local printer 260.

On-demand print server 210 accepts job orders from corporate users such as corporate user 230. Each job order accepted enters an order queue and is managed and processed by an order manager 270 with a web interface. Order manager 270 prioritizes jobs in the order queue, and routes them to available printers at a corporate reproduction center 280. Preferably, difficult orders are routed to an on-line on-demand print facility, such as that described in reference to FIG. 3 hereinbelow.

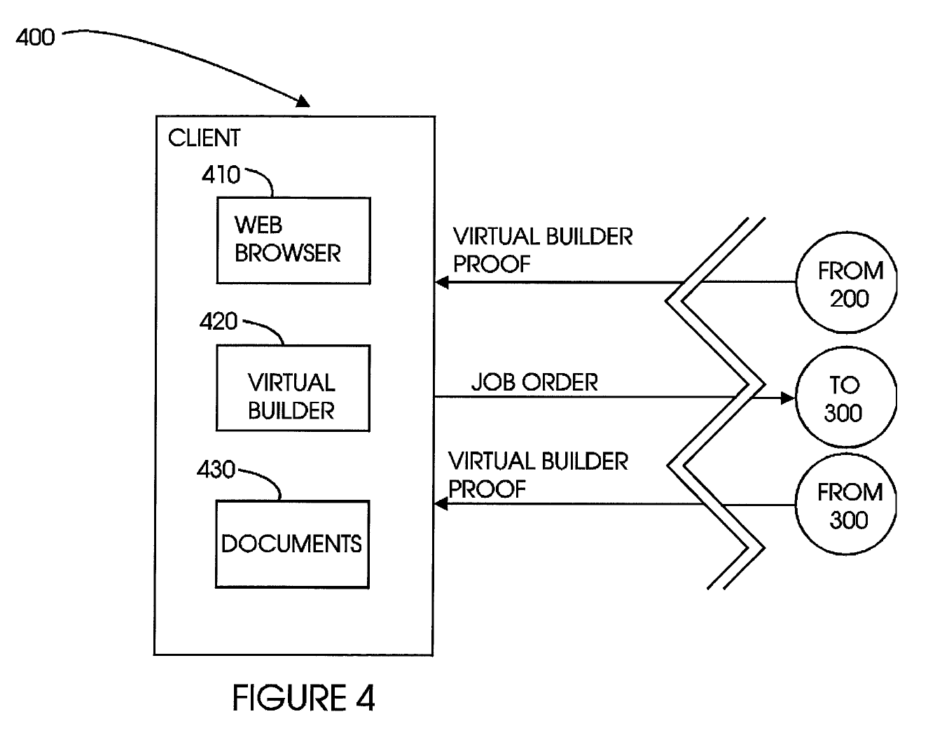

On-demand print server 210 also interfaces with a web server 290, so that corporate clients who are not situated within the corporate intranet, such as the client described with reference to FIG. 4 hereinbelow, may also order copies of corporate documents through their web browsers.

Order management software 270 also assigns job tracking identification numbers to job orders, and provides users such as corporate user 230 with status reports of their jobs upon request.

Reference is now made to FIG. 3, which illustrates components of an on-line printing service residing within an on-line on-demand printing facility 300, in accordance with a preferred embodiment of the present invention. On-line on-demand print facility 300 contains on-demand print service software 310 that includes Virtual Builder viewer software 320. On-demand print service is managed by an administration tool 330 that has a web interface. Administration tool 330 enables an administrator of an on-line on-demand printing facility to monitor job orders being processed and job orders waiting in queue. Administration tool 330 also enables an administrator to set various system configuration parameters, such as root directory, maximum number of threads, cache memory and other parameters.

On-demand print service 310 preferably works with a database of user accounts, including a database 340 of individual accounts and a database 350 of corporate accounts. On-demand print service 310 includes transaction software 360 for corporate billing and for individual billing. Preferably, corporate billing is implemented by a pre-arranged purchase order system, and individual billing is implemented by user created on-line accounts.

Preferably on-line on-demand print facility 300 includes its own production resources in local production center 370, and additionally has access to production resources in remote production centers such as remote production center 380. On-demand print service 310 prioritizes print jobs and routes them to printers in local production center 370 and in remote production center 380, based on the type of job and based on resource availability.

On-demand print service 310 also assigns job tracking identification numbers to job orders, and provides users with status reports of their jobs upon request.

Reference is now made to FIG. 4, which illustrates client software that uses an on-demand printing service of the present invention. A client computer 400 includes a web browser 410 and, preferably, Virtual Builder viewer software 420. Client 400 may access corporate documents on the on-demand print server 210 (FIG. 2), select finishing options and order copies. Alternatively, client 400 may use pre-selected finishing options stored in a job description file. Client 400 may also access the on-demand print service 310 (FIG. 3) to print local documents 430 stored on client 400. Alternatively, client 400 may access the on-demand print service 310 to print documents stored on other computers.

Software Architecture

In a preferred embodiment of the present invention, Virtual Builder includes a browser applet, referred to as the Virtual Builder client applet, and an associated server side communication engine, referred to as the Virtual Builder server. A Virtual Builder server is preferably part of a web server based on the Enhydra Java/XML application server. Such an application server can interpret HTTP, XML, JDBC and can host dynamic web applications. Information concerning the Enhydra application server is available on the web at http://www.enhydra.org.

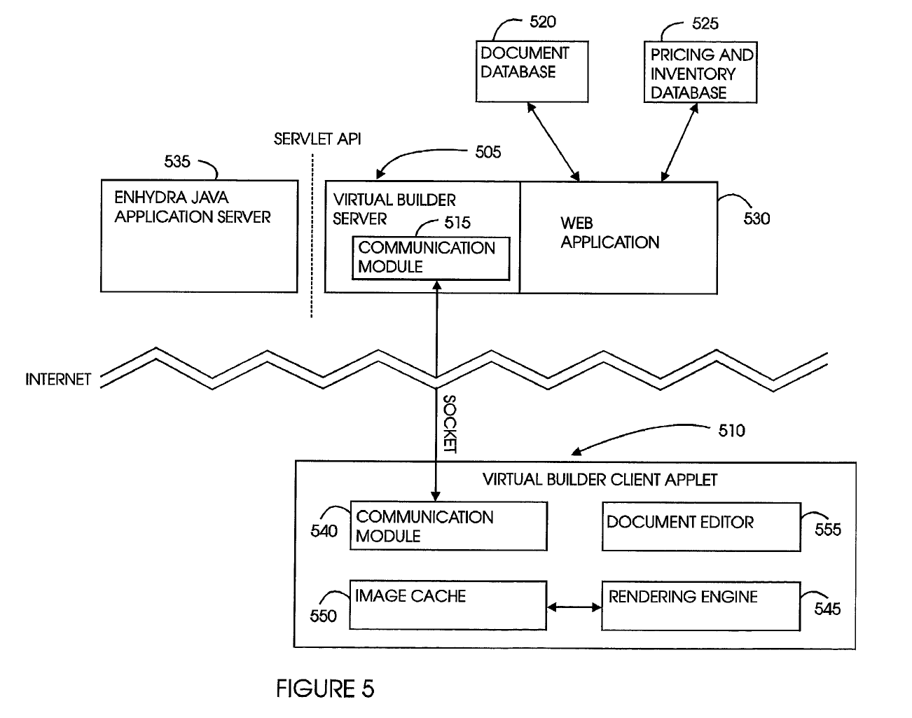

Reference is now made to FIG. 5, which illustrates software components interfacing with a Virtual Builder server 505 and a Virtual Builder client applet 510. Virtual Builder server 505 preferably interfaces with a server side communication module 515, with a document database 520, with pricing and inventory databases 525, and with the rest of a web application 530, such as an on-line ordering interface. Virtual Builder server 505 is preferably connected with an Enhydra Java application server 535 by a servlet API.

Virtual Builder client applet 510 is served up as part of the workflow in web application 530. Web application 530 invokes client applet 510 by sending a dynamic HTML page with an APPLET tag. Client applet 510 initiates communication with web application 530.

Once up and running on a client computer, client applet 510 continually communicates back with the server to request page impressions, paper swatch samples, and available binding and finishing options, as described hereinbelow. When authoring a document with Virtual Builder client applet 510, the finished document structure is sent to the server for final storage as an XML description.

Virtual Builder client applet 510 preferably includes a socket based communication module 540, a rendering engine 545 and associated image cache 550, and a document editor 555.

Virtual Builder client applet 510 is used in the following circumstances:

an ordering interface for composing and sending a document to a print-for-pay service;

a document authoring interface for a corporate document management system;

read-only viewing of a document for reordering; and

other circumstances where a virtual proofing is desired.

Virtual Builder client applet 510 is preferably used to render a number of different document types. To render a wide variety of different documents, Virtual Builder client applet 510 preferably takes on multiple forms, depending on the document type. Such multiple forms preferably share the same software for backend and communication logic, and differ only in their display and manipulation logic.

In a preferred embodiment of the present invention, the multiple forms of Virtual Builder client applet 510 correspond to the following document types:

Bound Documents. Such documents have covers, inserts, folded pages, binding and other finishing options. They consist of one or more pages.

Business Cards. Presentation of a business card is handled differently than presentation of a bound document. Owing to the unique design of business cards, the composition can be done on the server rather than as a downloaded source.

Letterhead and envelopes. Such documents are also handled separately, for reasons of their unique design.

Folded Documents. Such documents have one or more pages that are folded and either stitched or stapled together, Examples of folded documents include brochures, datasheets, mailing cards and newsletters.

It should be apparent to those skilled in the art that other specialized display engines can be added as necessary for other types of products, such as glossy marketing and advertising materials, t-shirts, mugs and mouse pads.

Implementation Details

In a preferred embodiment of the present invention, when a document, such as a PDF document, is submitted to a system of the present invention, a set of page images is created at the dpi resolution required by Virtual Builder client applet. Each page image preferably has sufficient detail so as to be able to provide a low resolution rendition of the page it represents, with correct formatting and with correct character fonts, colors and sizes. The page images are preferably enhanced using an anti-aliasing algorithm. The page images are preferably stored with the document on the server. Typically, for image-rich documents, storage of the page images requires a fraction of the memory that the document occupies.

Preferably the software performing the page image generation resides on a server computer. For PDF documents, such software preferably uses PDF library software, which provides an open interface for handling PDF documents and accessing the objects contained therewithin.

When page image generation software resides on a server computer, it is appropriate that the documents being processed also be resident on the server computer. This entails that remote documents be transmitted to the server computer.

When a client computer running Virtual Builder views a document as a finished document, page images of the document pages are transmitted from the server computer to the client computer. Preferably, page images are pre-fetched in an order and in a manner optimized to provide a user with an uninterrupted interactive viewing experience. For example, in a preferred embodiment of the present invention, the client initially downloads the page images of the first pages in sequential order, based on the assumption that a user will interactively advance through the document pages in ascending order. The transmission of successive page images is performed asynchronously, in a push mode from the server computer, regardless of whether or not the user is actually viewing the corresponding pages, based on anticipation that the user will continue to view the document pages in sequential order.

If, however, the user jumps forward to a later page in the document, the client will request the page image of the later page in a pull mode. Such a pull request from the client pre-empts the asynchronous transmission of pages in the push mode from the server. If the system detects that the user is interactively turning pages forward from the later page that he jumped to, then the server pushes later pages asynchronously in succession. Similarly, if the system detects that the user is interactively turning pages backward from the later page, then the server pushes earlier pages asynchronously in succession. For both forward and backward paging, the asynchronous transmission is effective to provide the page images in anticipation of the viewing thereof, avoiding interruptions that can be caused by network latency.

Thus it can be seen that the client-server interaction is used to provide as uninterrupted a viewing experience as possible for the user, by a combination of asynchronous transmission of page images in a server push mode, and pre-emptive download of page images in a client pull mode.

When a user of a system of the present invention wishes to view, edit or create a new document, the Virtual Builder client applet is invoked inside of a web page. The HTTP socket connection used to serve up the applet is maintained open as a communication channel to the server. While the user is using the Virtual Builder client applet, resources such as XML job description pages, page images and other graphic objects are requested from the server through communication module 540 and cached in the applet. As the user interactively navigates through a document and modifies it, the Virtual Builder client applet keeps the complete state of user manipulation, until this information is explicitly sent back to the server for persistent storage.

In a preferred embodiment of the present invention, Virtual Builder operates by layering document text over textured images of finishing features, as described in what follows.

With each finishing option there is associated one or more graphic objects and layout instructions to render the way it appears. The graphic objects are fetched from a server upon request by Virtual Builder. Preferably the graphic objects and layout instructions are stored as JPEG image data, as GIF image data with transparency, or as JAVA serialized objects from a JAVA IO package. Graphic objects include page images, one image per page of a document, paper media images, tab inserts, bindings, drill holes, staples, and sheen for glossy media types.

To render a selected page of a document, Virtual Builder client applet fetches a page image from the server, to generate an image of the page. If necessary, the page image is rotated by 90 degrees, so that Virtual Builder can accommodate both portrait and landscape page layouts. Optionally, Virtual Builder may apply an ICC color profile, to render accurate colors of the page image. Preferably the page images are adjusted for paper size, and composited with opacity levels determined in such a way that the texture and color of the paper grain is noticeable in the characters, so that the virtual finished document matches the appearance of the physical finished document it depicts, as described hereinbelow.

Regarding paper, each distinct grain of paper is preferably represented by an image tile, or swatch, that can be repeatedly patched in a mosaic layout to generate a textured paper image; i.e., a bitmap image of the texture of the paper grain.

It should be apparent to those skilled in the art that other methods for texture generation can be used, instead of tiling. For example, texture can be generated by fractal algorithms that repeatedly apply one or more mathematical transformations.

In addition to generating texture of paper grain by tiling, it may also be necessary to adjust the textured paper image for paper size and for paper color. It may also be necessary to rotate the textured paper image by 90 degrees, so that portrait or landscape page layouts can be displayed.

In a preferred embodiment of the present invention, paper image tiles are not stored on the server for every possible color of paper, as this would require an enormous library of images. Rather, they are stored for one or more reference colors, such as grayscale, and selected paper colors are imposed upon request. Optionally, Virtual Builder may apply ICC color profiles, to render accurate colors of the textured paper image.

Preferably, for single color paper with smooth grain, a bitmap image of the page can be created on a client computer, without the need to download an image tile.

To composite the page image onto the textured paper image, the color channel values of the page image pixels are preferably multiplied by the corresponding color channel values of the textured paper image pixels. Since color channels are typically encoded as 8 bit unsigned integers, multiplication is performed by converting one of the multiplicands to a floating point value between 0 and 1. Alternatively, the multiplicands can be kept as unsigned integers, and their resulting product can be converted to an 8 bit unsigned integer by dividing by 256; i.e., by right-shifting 8 bits of the product. It is apparent to those skilled in the art that for other types of color channel encodings, similar operations may be used to ensure that the result of multiplying two color channel values produces a valid color channel value.

Multiplying page image color values by textured paper image color values has several advantages, including (i) correct rendering of color copies on colored paper, and (ii) simulation of dye on top of paper.

If the paper is glossy, then a sheen image is also fetched from the server and applied. A sheen image is preferably a grayscale image. To apply gloss, each pixel color of the page image is preferably modified to be a linear combination of its original color and white, where the weighting is based upon the respective sheen pixel intensities. If the paper is laminated, then a laminated image is also fetched from the server and applied. Preferably, lamination is applied by multiplying color channel values of page image pixels by corresponding color channel values of lamination image pixels.

A drop shadow is preferably used as background. The shape of the drop shadow is determined by the choice of paper. Optionally, the drop shadow can be enhanced using masking images for tabs and drill holes. The drop shadow is rendered once, its edges are feathered and it is cached for re-use.

Left and right pages are rendered next to one another. The spacing between the pages is based on choices of binding, stapling and drilling. If the document is left-bound, then the pages are arranged next to one another horizontally. If the document is top bound, then the pages are arranged above one another vertically.

Regarding binding, preferably at least three image tiles are used to represent binding: one image tile being used to display the way the binding appears when viewing the front of the document, a second image tile being used to display the way the binding appears when viewing pages in the middle of the document, and a third image tile being used to display the way the binding appears when viewing the back of the document. When the user selects binding options, the binding image tiles are fetched from the server. As described above with reference to paper texture, the image tiles used for binding are patched together in a mosaic pattern to fill in spacing between displayed pages. Spacing parameters are preferably part of a job description file.

As with paper grain, images used for displaying bindings may have to be adjusted for size and color of the binding. In addition, for spiral bindings, such images may also have to be adjusted for inside page margins, so that the text on a page is appropriately offset from the spiral of the binding.

Moreover, when compositing an image of binding over an image with paper grain texture, it is preferable to apply color correction so that the binding and the paper grain blend aesthetically.

Regarding drilling and stapling, Virtual Builder client applet fetches appropriate images from the server and composites them onto the displayed pages.

Other finishing options, such as front and back covers, and tab inserts are also preferably represented by appropriate images that are composited one with another.

Preferably the compositing operations described hereinabove are performed in a memory buffer off-screen, rather than directly on-screen. The final result image, with all of the finishing options composited, is copied from the buffer to the screen for display. By performing the compositing off-screen, Virtual Builder avoids flickering artifacts that would arise were the various image compositions described hereinabove to be performed directly on a screen image.

Regarding page turning (“flipping pages”), when a user advances to a next page or goes back to a previous page, the image of the new page is created as described hereinabove. The current image and new image are used to animate the page turning.

In a preferred embodiment of the present invention, the page turning algorithm used in Virtual Builder is implemented as follows. Letting O1 and O2 denote the left and right old pages, respectively, and letting N1 and N2 denote the left and right new pages, respectively, a right-to-left page turn (i.e., a page advance) is animated using the following sequence of steps:

Display O1 next to O2 (original view)

Display O1 next to O2 horizontally compressed and left justified. The remainder of the space that O2 occupied is used to display the rightmost portion of N2.

Repeat the above step multiple times, where the horizontal compression factor equals cos(t), as t ranges from 0 (full display of O2 and no display of N2) to π/2 (no display of O2 and full display of N2).

Display O1 next to N2

Display O1 partially obscured by a horizontally compressed right justified image of N1 next to N2.

Repeat the above step multiple times, where the horizontal compression factor equals cos(t), as t ranges from π/2 (full display of O1 and no display of N1) to 0 (no display of O1 and full display of N1).

Display N1 next to N2.

Repeating the compression steps with compression factors cos(t) gives an illusion of page turning.

Folding is animated in a manner similar to page turning, using page flips. Unfolding is animated as the reverse animation to folding.

In a preferred embodiment of the present invention, Virtual Builder controls the web browser display on the client computer. In such a case, the various layers of image compositing and text overlay that are carried out by Virtual Builder do not have to be embedded within an HTML page or within another such standard layout page.

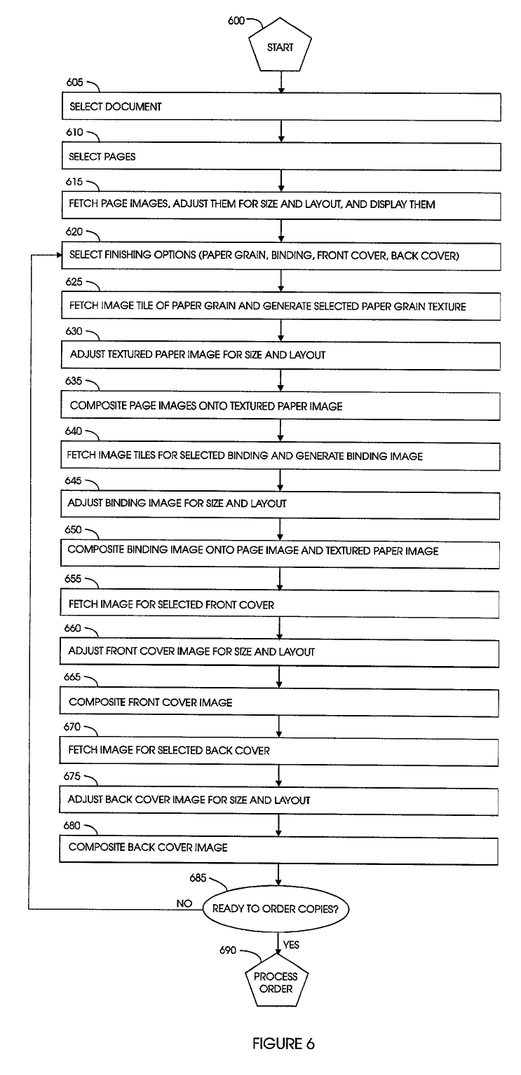

Reference is now made to FIG. 6, which is a simplified flowchart of the operation of Virtual Builder in an example user session, in accordance with a preferred embodiment of the present invention. At step 600 a user starts by invoking a Virtual Builder viewer application. At step 605 the user selects a document. The document may already be stored on a server computer, and already have images of its pages generated. Otherwise, the document is transmitted to the server computer and processed so as to generate images of its pages, as described hereinabove. At step 610 the user selects one or more pages of the document to view.

At step 615 Virtual Builder client applet fetches the appropriate page images from a server, adjusts them for size and layout, and displays them. Alternatively, the page images may have already been partially or fully adjusted on the server.

At step 620 the user selects a set of finishing options, including paper characteristics—paper grain, color and size, binding options, and front and back covers.

At step 625 Virtual Builder fetches an image tile appropriate to the paper grain that was selected by the user at step 620, and copies the image tile repeatedly in the form of a mosaic so as to generate an image of the paper grain texture. At step 630 Virtual Builder adjusts the image of the paper grain texture according to the color of the paper selected by the user at step 620 and according to the size and layout of the pages. Alternatively, the image tiles may have already been partially or fully adjusted on the server. For example, the server may do the adjustment for color, but not for size. At step 635 Virtual Builder composites the page image onto the textured paper image for one or more document pages.

At step 640 Virtual Builder fetches image tiles according to the type of binding that was selected by the user at step 620, and copies the binding tiles repeatedly so as to generate an image of the binding. At step 645 Virtual Builder adjusts the binding image for size, color and margins. Alternatively, the image tiles may have already been partially or fully adjusted on the server. At step 650 Virtual Builder composites the binding image onto the page image and textured paper image, so that it seamlessly combines with the textured page.

At step 655 Virtual Builder fetches an image of the front cover that was selected by the user at step 620. At step 660 Virtual Builder adjusts the front cover image for size and color. Alternatively, the front cover image may have already been partially or fully adjusted on the server. At step 665 Virtual Builder composites the front cover image with the binding image and with any other images that appear with the front cover, so that it seamlessly combines with the binding image.

At step 670 Virtual Builder fetches an image of the back cover selected by the user at step 620. At step 675 Virtual Builder adjusts the back cover image for size and color. Alternatively, the back cover image may have already been partially or fully adjusted on the server. At step 680 Virtual Builder composites the back cover image with the binding image and with any other images that appear with the back cover, so that it seamlessly combines with the binding image.

At step 685 the user decides whether or not he is satisfied with the finished document being displayed, and is ready to process his order. If he is ready to process his order, then he does so at step 690. If not, he returns to step 620 and selects alternate finishing options.

In reading the above description, persons skilled in the art will realize that there are many apparent variations that can be applied to the methods and systems described. For example, although the discussion above indicates the use of image tiles for textured paper images and binding images, and the use of full images for other finishing options, it is apparent that either image tiles or full images may be employed to represent textured paper images, binding images, tab insert images, drilling images, staple images, sheen images, lamination images, and other images of finishing options.

Additionally, although the discussion with reference to FIG. 6 indicates that the user chooses all of the finishing options at once, this is only for the sake of conciseness, and it is apparent that these options may be chosen at various stages of the virtual proofing, and need not be chosen at a single stage.

Additionally, although the discussion of FIG. 6 indicates that page images and other images are fetched upon request, it is apparent that such images can be pre-fetched, in which case they are readily available to the client applet.

Additionally, Virtual Builder can incorporate rules regarding the design of finished documents. For example, such a rule might be that “you cannot use a glue binding with heavy weight paper.” Virtual Builder can preclude such a design by disabling glue binding in the binding selection list if a heavy weight paper is already selected, or vice versa. Alternatively, if a user selects both a heavy weight paper and a glue binding, Virtual Builder can pop up a message box with an error message, similar to the way Microsoft Excel pops up a message box if a user introduces a circular reference into a spreadsheet.

Similarly, Virtual Builder can also include tips. For example, such a tip might be that “you should not use a glue binding with heavy weight paper, as it might fall apart.” If a user selects both a heavy weight paper and a glue binding, Virtual Builder can pop up a message box with a tip. In this way, Virtual Builder acts as a guide for the user to create a finished document that is well designed.

Tips can also be price conscious. For example, such a tip might be that “if you can cut out two pages of your booklet, the cost of the job will go down by 25%, since it will require much less paper stock.” In this way, Virtual Builder can incorporate the educated and experienced advice a customer normally gets from print salesmen.

Similarly, along with rules and tips, Virtual Builder can include a capability to control allowable product sets. Allowable product sets can be used to restrict a user from applying various finishing options or combinations of finishing options. For example, a corporation can restrict its users from printing documents in color. It may also restrict its users from applying finishing options that are priced higher than corresponding prices of alternative print service providers.

Additionally, Virtual Builder can include a capability to search among registered print companies to find the one that can print a finished document at the lowest price.

Additionally, Virtual Builder can act as a “print broker,” whereby a user specifies his job requirements, such as turnaround and price, and Virtual Builder searches among registered print companies to find the ones who can fulfill the requirements. In this way, the on-line print service that Virtual Builder offers becomes more valuable to its users, who benefit from its services, and more valuable to its registered print companies, who receive job orders from around the world and save costs of sales and marketing staff.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A method for creating and viewing content to be printed, comprising the steps of:
receiving an electronic document;
selecting, in response to user input, finishing options for the electronic document; and
displaying, in response to said selecting, how the electronic document would appear as a finished document, if printed in accordance with the finishing options.

2. The method of claim 1 wherein the finishing options include paper characteristics.

3. The method of claim 1 wherein the finishing options include descriptions of front and back covers.

4. The method of claim 1 wherein the finishing options include binding instructions.

5. The method of claim 1 wherein the finishing options including tab insert characteristics.

6. The method of claim 1 wherein the finishing options include folding instructions.

7. The method of claim 1 wherein the finishing options include hole punching instructions.

8. The method of claim 1 wherein the finishing options include lamination characteristics.

9. The method of claim 1 further comprising the step of storing the finishing options electronically.

10. The method of claim 1 further comprising the step of computing costs for printing the electronic document in accordance with the finishing options.

11. The method of claim 10 further comprising the step of processing a customer order to print a prescribed number of copies of the electronic document in accordance with the finishing options.

12. The method of claim 11 further comprising the step of assigning a job tracking number to the customer order.

13. The method of claim 11 further comprising the step of providing status information regarding the customer order based on the job tracking number.

14. The method of claim 11 further comprising the step of billing a customer for the customer order.

15. The method of claim 11 further comprising the step of scheduling production work in a production center based on the customer order, to generate one or more printed documents.

16. The method of claim 15 further comprising the step of scheduling delivery of the one or more printed documents to a customer.

17. A method for creating and viewing content to be printed, comprising the steps of:
receiving an electronic document;
selecting, in response to user input, finishing options for the electronic document; and
storing the finishing options electronically.

18. The method of claim 17 wherein the finishing options include paper characteristics.

19. The method of claim 17 wherein the finishing options include descriptions of front and back covers.

20. The method of claim 17 wherein the finishing options include binding instructions.

21. The method of claim 17 wherein the finishing options including tab insert characteristics.

22. The method of claim 17 wherein the finishing options include folding instructions.

23. The method of claim 17 wherein the finishing options include hole punching instructions.

24. The method of claim 17 wherein the finishing options include lamination characteristics.

25. The method of claim 17 further comprising the step of displaying, in response to said selecting, how the electronic document would appear as a finished document, if printed in accordance with the finishing options.

26. The method of claim 17 further comprising the step of computing costs for printing the electronic document in accordance with the finishing options.

27. The method of claim 26 further comprising the step of processing a customer order to print a prescribed number of copies of the electronic document in accordance with the finishing options.

28. The method of claim 27 further comprising the step of assigning a job tracking number to the customer order.

29. The method of claim 27 further comprising the step of providing status information regarding the customer order based on the job tracking number.

30. The method of claim 27 further comprising the step of billing a customer for the customer order.

31. The method of claim 27 further comprising the step of scheduling production work in a production center based on the customer order, to generate one or more printed documents.

32. The method of claim 31 further comprising the step of scheduling delivery of the one or more printed documents to a customer.

33. A system for creating and viewing content to be printed, comprising:
a document acquisition unit receiving an electronic document;
a user interface setting, in response to user input, finishing options for the electronic document; and
a display device displaying how the electronic document would appear as a finished document, if printed in accordance with the finishing options.

34. The system of claim 33 wherein the finishing options include paper characteristics.

35. The system of claim 33 wherein the finishing options include descriptions of front and back covers.

36. The system of claim 33 wherein the finishing options include binding instructions.

37. The system of claim 33 wherein the finishing options including tab insert characteristics.

38. The system of claim 33 wherein the finishing options include folding instructions.

39. The system of claim 33 wherein the finishing options include hole punching instructions.

40. The system of claim 33 wherein the finishing options include lamination characteristics.

41. The system of claim 33 further comprising a memory storing the finishing options electronically.

42. The system of claim 33 further comprising a cost processor computing costs for printing the electronic document in accordance with the finishing options.

43. The system of claim 42 further comprising a transaction processor processing a customer order to print a prescribed number of copies of the electronic document in accordance with the finishing options, and billing a customer for the customer order.

44. The system of claim 43 further comprising a job tracking processor assigning a job tracking number to the customer order.

45. The system of claim 43 further comprising a status processor providing status information regarding the customer order based on the job tracking number.

46. The system of claim 43 further comprising a scheduler scheduling production work in a production center based on the customer order.

47. A system for creating and viewing content to be printed, comprising:
a document acquisition unit receiving an electronic document;
a user interface setting, in response to user input, finishing options for the electronic document; and
a memory storing the finishing options electronically.

48. The system of claim 47 wherein the finishing options include paper characteristics.

49. The system of claim 47 wherein the finishing options include descriptions of front and back covers.

50. The system of claim 47 wherein the finishing options include binding instructions.

51. The system of claim 47 wherein the finishing options including tab insert characteristics.

52. The system of claim 47 wherein the finishing options include folding instructions.

53. The system of claim 47 wherein the finishing options include hole punching instructions.

54. The system of claim 47 wherein the finishing options include lamination characteristics.

55. The system of claim 47 further comprising a display device displaying how the electronic document would appear as a finished document, if printed in accordance with the finishing options.

56. The system of claim 47 further comprising a cost processor computing costs for printing the electronic document in accordance with the finishing options.

57. The system of claim 56 further comprising a transaction processor processing a customer order to print a prescribed number of copies of the electronic document in accordance with the finishing options, and billing a customer for the customer order.

58. The system of claim 57 further comprising a job tracking processor assigning a job tracking number to the customer order.

59. The system of claim 57 further comprising a status processor providing status information regarding the customer order based on the job tracking number.

60. The system of claim 57 further comprising a scheduler scheduling production work in a production center based on the customer order.

61. A method for viewing content to be printed using electronically stored finishing options, comprising the steps of:
retrieving the finishing options; and
displaying the electronic document in accordance with the finishing options.

62. A system for viewing content to be printed using electronically stored finishing options, comprising:
a memory storing the finishing options; and
a display device displaying the electronic document in accordance with the finishing options.
